(19) United States
(12) Patent Application Publication
(10) Pub. No.: US 2024/0118929 A1
(43) Pub. Date: Apr. 11, 2024

(54) SYSTEM AND METHOD FOR A MACHINE LEARNING ARCHITECTURE FOR RESOURCE ALLOCATION

(71) Applicant: ROYAL BANK OF CANADA, Toronto (CA)

(72) Inventors: Lili MENG, Vancouver (CA); Tristan Jean Claude SYLVAIN, Montreal (CA); Amir Hossein ABDI, Vancouver (CA); Gabriel OLIVEIRA, Vancouver (CA); Yunduz RAKHMANGULOVA, Vancouver (CA); Yongmin YAN, Vancouver (CA); Ella WILSON, Vancouver (CA); Robert David EVANS, Vancouver (CA); Saghar IRANDOUST, Vancouver (CA); Christopher Côté SRINIVASA, Toronto (CA)

(21) Appl. No.: 18/238,397

(22) Filed: Aug. 25, 2023

Related U.S. Application Data
(60) Provisional application No. 63/411,416, filed on Sep. 29, 2022.

(51) Int. Cl. G06F 9/50

(52) U.S. Cl. CPC G06F 9/5027; G06F 9/5077

(57) ABSTRACT

A system and method for machine learning architecture for prospective resource allocations are described. The method may include: receiving data records representing historical resource allocations from a user account associated with a first identifier to a resource account associated with a second identifier; deriving input features based on the data records; computing, using a trained neural network architecture, a predicted resource allocation amount and a predicted resource allocation date for the predicted resource allocation amount based on the derived input features; determining, using the trained neural network architecture, a first selection score associated with the predicted resource allocation amount and a second selection score associated with the predicted resource allocation date; and when the first or second selection score is above a minimum threshold, causing to display, at a display device, the associated resource allocation amount or date corresponding to the second identifier.

### CROSS-REFERENCE TO RELATED APPLICATION

This application claims the benefit of and priority to U.S. provisional patent application No. 63/411,416 filed on Sep. 29, 2022, the entire content of which is herein incorporated by reference.

### FIELD

Embodiments of the present disclosure generally relate to the field of machine learning and, in particular, to machine learning architecture for resource allocation prediction.

### BACKGROUND

A resource pool may include one or more of currency or cash equivalent, precious metals, energy, computing resources, or other types of resources. Computing systems may be configured to execute data processes to allocate resources among data records associated with one or more entities. Such data records may be stored at one or more disparate data storage devices, such as databases or servers of utility providers, disparate banking institutions, employer institutions, retail entities, or the like.

In some situations, data processes to allocate resources may be temporally recurring. For example, a customer or user of a banking institution may conduct substantially periodic resource allocations over time to third party entities (e.g., paying user utility bills on a monthly basis, among other examples).

### SUMMARY

Embodiments of the present disclosure are directed to systems and methods for sequential data process modelling. In particular, systems and methods may be configured to receive a sequence of data records representing prior resource allocations and generate prospective data records representing prospective resource allocations for a predicted future point in time.

As disclosed herein, resource allocations may include allocation or distribution of resources to one or more user accounts, typically on a recurring basis. For instance, a user (or household) having a user account registered with a utility provider may consume electricity in the amount of between 500 to 1000 kWh per month. The data records associated with the user account from the utility provider system may include records indicating a monthly consumption amount of electricity for each month, as metered for a specific unit (e.g., a house or an apartment) associated with the user account. The data records indicating the monthly consumption of electricity may further include data representing a billed amount for the respective monthly consumption of electricity. Each billed amount, in monetary value, is also a form of resource consumption as the user makes one or more payments based on the billed amount for the consumed electricity.

The data records representing the monthly resource consumption of electricity and/or the monthly payment for the resource consumption of electricity, may be processed using a machine learning architecture to generate prospective data records representing prospective resource allocations for a predicted future point in time. The prospective resource allocation may include a predicted resource consumption of electricity, and/or a predicted resource consumption of payment for the predicted consumption of electricity.

In some embodiments, based on the generated prospective data records representing prospective resource allocation(s), one or more control options may be generated and displayed by an embodiment of a system to a user to manage the resource consumption. For example, the control options may allow the user to pre-emptively change, limit or otherwise configure (or control) the resource consumption in view of the generated prospective resource allocation, with one or more user input including a value for a user-adjustable parameter. The system may generate and route the control commands based on the received user input to cause another system or server, either internal or external, to implement the user-specified changes, limits or configurations of the resource consumption.

In accordance with one aspect, there is a system for machine learning architecture for prospective resource allocations, the system may include: a processor; and a memory coupled to the processor and storing processor-executable instructions that, when executed, configure the processor to: receive a sequence of data records representing historical resource allocations from a user account associated with a first identifier to a resource account associated with a second identifier; derive input features based on the sequence of data records representing the historical resource allocations; compute, using a trained neural network architecture, a predicted resource allocation amount and a predicted resource allocation date for the predicted resource allocation amount associated with the first identifier and the second identifier based on the derived input features; determine, using the trained neural network architecture, a first selection score associated with the predicted resource allocation amount and a second selection score associated with the predicted resource allocation date; and when the first or second selection score is above a minimum threshold, cause to display, at a display device, the associated resource allocation amount or date corresponding to the second identifier.

In some embodiments, the processor-executable instructions that, when executed, configure the processor to: cause to render, at the display device, one or more graphical user interface elements displaying a user-adjustable parameter for controlling a resource consumption associated with the resource account; receive at least one user input representative of a value for the user-adjustable parameter; generate a command signal based on the value for the user-adjustable parameter; and transmit the command signal to an external server for controlling the resource consumption associated with the resource account.

In some embodiments, the processor-executable instructions that, when executed, configure the processor to: generate one or more recommended values for the user-adjustable parameter based on the historical resource allocations from the user account; and cause to render, at the display device, the one or more graphical user interface elements displaying the user-adjustable parameter for controlling the resource consumption associated with the resource account with the one or more recommended values.

In some embodiments, the processor-executable instructions that, when executed, configure the processor to: compute, using the trained neural network architecture, an updated predicted resource allocation amount associated with the first identifier and the second identifier based on the derived input features and the value for the user-adjustable parameter for controlling the resource consumption associated with the resource account; and cause to display, at the display device, the updated predicted resource allocation amount.

In some embodiments, the trained neural network architecture comprises a residual long short-term memory (LSTM) network including blocks of stacked LSTMs with residual connections between blocks.

In some embodiments, an input to the LSTM network comprises a feature vector comprising a concatenation of a plurality of input features.

In some embodiments, during training of the neural network architecture, the neural network architecture is configured to generate a plurality of outputs associated with one or more time steps, the plurality of outputs comprising: a predicted head amount, a predicted auxiliary amount, an amount selection score, a predicted head date-delta, a predicted auxiliary date-delta, and a date selection score.

In some embodiments, the training of the trained neural network architecture is based on the predicted auxiliary amount and the predicted auxiliary date-delta.

In some embodiments, the processor-executable instructions that, when executed, configure the processor to: generate one or more adjusted prospective resource allocations corresponding to the second identifier based on self-attention operations, wherein the adjusted prospective resource allocations comprise a dynamic weighted average of prior observed resource allocation values.

In some embodiments, a plurality of weights in the dynamic weighted average are determined based on a current output representation of the neural network architecture at a current time step and one or more previous output representations of the neural network architecture from one or more previous time steps.

In accordance with one aspect, there is a computer-implemented method for machine learning architecture for prospective resource allocation, the method may include: receiving a sequence of data records representing historical resource allocations from a user account associated with a first identifier to a resource account associated with a second identifier; deriving input features based on the sequence of data records representing the historical resource allocations; computing, using a trained neural network architecture, a predicted resource allocation amount and a predicted resource allocation date for the predicted resource allocation amount associated with the first identifier and the second identifier based on the derived input features; determining, using the trained neural network architecture, a first selection score associated with the predicted resource allocation amount and a second selection score associated with the predicted resource allocation date; and when the first or second selection score is above a minimum threshold, causing to display, at a display device, the associated resource allocation amount or date corresponding to the second identifier.

In some embodiments, the method may further include: causing to render, at the display device, one or more graphical user interface elements displaying a user-adjustable parameter for controlling a resource consumption associated with the resource account; receiving at least one user input representative of a value for the user-adjustable parameter; generating a command signal based on the value for the user-adjustable parameter; and transmitting the command signal to an external server for controlling the resource consumption associated with the resource account.

In some embodiments, the method may further include: generating one or more recommended values for the user-adjustable parameter based on the historical resource allocations from the user account; and causing to render, at the display device, the one or more graphical user interface elements displaying the user-adjustable parameter for controlling the resource consumption associated with the resource account with the one or more recommended values.

In some embodiments, the method may further include: computing, using the trained neural network architecture, an updated predicted resource allocation amount associated with the first identifier and the second identifier based on the derived input features and the value for the user-adjustable parameter for controlling the resource consumption associated with the resource account; and causing to display, at the display device, the updated predicted resource allocation amount.

In some embodiments, the trained neural network architecture comprises a residual long short-term memory (LSTM) network including blocks of stacked LSTMs with residual connections between blocks.

In some embodiments, an input to the LSTM network comprises a feature vector comprising a concatenation of a plurality of input features.

In some embodiments, during training of the neural network architecture, the neural network architecture is configured to generate a plurality of outputs associated with one or more time steps, the plurality of outputs comprising: a predicted head amount, a predicted auxiliary amount, an amount selection score, a predicted head date-delta, a predicted auxiliary date-delta, and a date selection score.

In some embodiments, the training of the trained neural network architecture is based on the predicted auxiliary amount and the predicted auxiliary date-delta.

In some embodiments, the method may further include: generating one or more adjusted prospective resource allocations corresponding to the second identifier based on self-attention operations, wherein the adjusted prospective resource allocations comprise a dynamic weighted average of prior observed resource allocation values.

In some embodiments, a plurality of weights in the dynamic weighted average are determined based on a current output representation of the neural network architecture at a current time step and one or more previous output representations of the neural network architecture from one or more previous time steps.

In accordance with yet another aspect, there is provided a non-transitory computer-readable medium having stored thereon machine interpretable instructions which, when executed by a processor, cause the processor to perform: receiving a sequence of data records representing historical resource allocations from a user account associated with a first identifier to a resource account associated with a second identifier; deriving input features based on the sequence of data records representing the historical resource allocations; computing, using a trained neural network architecture, a predicted resource allocation amount and a predicted resource allocation date for the predicted resource allocation amount associated with the first identifier and the second identifier based on the derived input features; determining, using the trained neural network architecture, a first selection score associated with the predicted resource allocation amount and a second selection score associated with the predicted resource allocation date; and when the first or second selection score is above a minimum threshold, causing to display, at a display device, the associated resource allocation amount or date corresponding to the second identifier.

Many further features and combinations thereof concerning embodiments described herein will appear to those skilled in the art following a reading of the present disclosure.

### BRIEF DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a system for predicting a resource consumption, in accordance with embodiments of the present disclosure;

FIG. 2A illustrates a block diagram of a portion of a machine learning model including a residual long short-term memory (LSTM) network, in accordance with embodiments of the present disclosure;

FIG. 2B illustrates a block diagram of an example neural network, in accordance with embodiments of the present disclosure;

FIG. 3 illustrates a block diagram of a machine learning architecture including a LSTM network, in accordance with embodiments of the present disclosure;

FIG. 4A illustrates an example user interfaces for displaying forecasts of prospective resource allocation and a predicted payment date for the resource allocation, in accordance with embodiments of the present disclosure;

FIG. 4B illustrates an example user interfaces for displaying user control options for a resource consumption, in accordance with embodiments of the present disclosure;

FIG. 5 illustrates a flowchart of a process, in accordance with embodiments of the present disclosure;

FIG. 6 illustrates a schematic diagram of an example computing device that implements a system (e.g., one or more components of system 100), in accordance with an embodiment;

FIG. 7 shows an example set of data records associated with a payee amount with the effect of self-attention; and

FIGS. 8 to 13 each shows an example set of data records from a respective resource account with respective training results.

### DETAILED DESCRIPTION

Embodiments of systems and methods are described here, the systems including a machine learning architecture configured to forecast a prospective resource allocation associated with a forecasted or predicted future date.

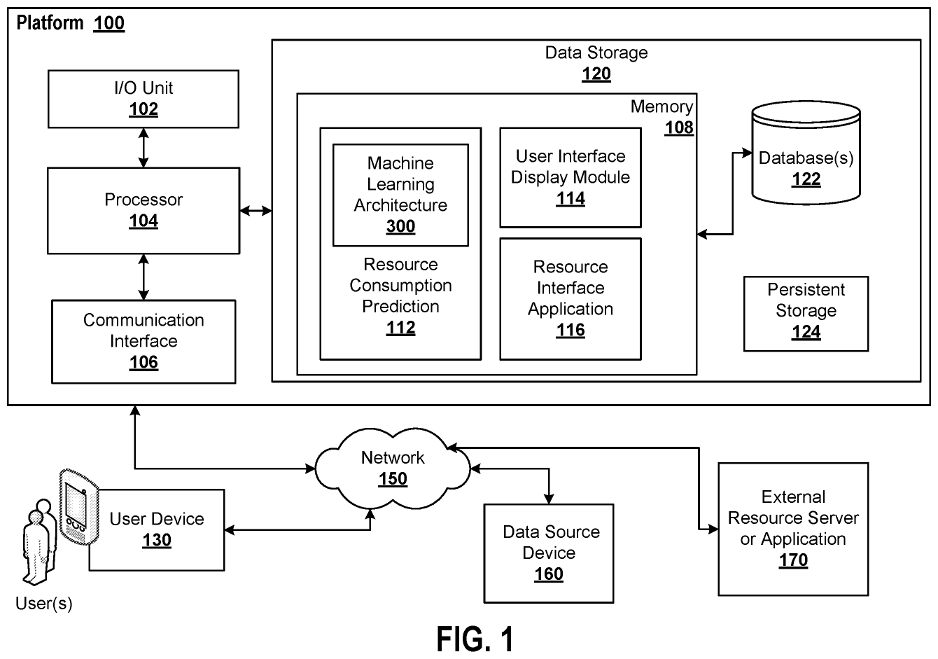

FIG. 1 is a high-level schematic diagram of an example computer-implemented system 100 (also referred to as platform 100) for predicting a resource consumption, exemplary of some embodiments. System 100 includes an I/O unit 102, a processor 104, communication interface 106, and data storage 120. The I/O unit 102 can enable system 100 to interconnect with one or more input devices, such as a keyboard, mouse, camera, touch screen and a microphone, and/or with one or more output devices such as a display screen and a speaker.

Data storage 120 includes a memory device 108 (also referred to as memory 108), a local database 122, and persistent storage 124. Memory 108 include one or more instruction modules stored thereon, such as for example, resource consumption prediction application 112, user interface (UI) display module 114 and a resource interface application 116.

Processor 104 is configured to execute machine-executable instructions to perform processes disclosed herein, including for example, generating one or more prospective resource allocations associated with a resource by resource consumption prediction application 112, generating one or more signals for displaying or rendering one or more user interface elements by UI display module 114, and generating one or more commands for external resource servers or applications 170 via resource interface application 116 based on user input.

System 100 can connect to an interface application installed on user device 130 to exchange signals representing one or more data records and user interface elements. The interface application interacts with system 100 to exchange data (including control commands) and renders visual elements for display at user device 130 based on signals from system 100.

System 100 can connect to different data sources, including third party sources such as data source devices 160 or external resource server or application 170, to receive input data or to transmit other data. The data can be transmitted and received via network 150 (or multiple networks), which is capable of carrying data and can involve wired connections, wireless connections, or a combination thereof. Network 150 may involve different network communication technologies, standards and protocols, for example.

Processor 104 can execute instructions in memory 108 to implement aspects of processes described herein. Processor 104 can execute instructions in memory 108 to configure various components and functions described herein. Processor 104 can be, for example, any type of microprocessor or microcontroller, a digital signal processing (DSP) processor, an integrated circuit, a field programmable gate array (FPGA), a reconfigurable processor, or any combination thereof.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

Communication interface 106 can enable system 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

System 100 can be operable to register and authenticate users (using a login, unique identifier, and password for example) prior to providing access to system 100. For example, user authentication process may be handled via an authentication module (not shown).

Data storage 120 may be configured to store information associated with or created by the components in memory 108 and may also include machine executable instructions. Memory 108 may be persistent memory storage. Data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

Resource consumption prediction application 112 (“resource application 112”) may include processor-readable instructions for conducting operations described herein. In some examples, resource application 112 may include a machine learning architecture 300, which may be a neural network architecture 300, is implemented to execute trained machine learning models 110, 220 at inference time to forecast prospective resource allocations associated with future points in time. Resource allocations may include allocation or distribution of resources to one or more user accounts, typically on a recurring basis. For example, determined resource availability for prospective resource allocations may include resource application representing a user's resource liquidity position associated with banking or monetary currency resources, including how much cash the user may have at a particular future point in time to meet a forecasted demand for a prospective resource allocation.

In some embodiments, databases 122 may store resource data sets received from a number of data sources including for example, data source device 160, data sets associated with historical resource transaction data, or other data sets for administering resource allocations among resource pools.

For another example, a user (or household) having a user account registered with a utility provider may consume electricity in the amount of between 500 to 1000 kWh per month. The data records associated with the user account from the utility provider system may include records indicating a monthly consumption amount of electricity for each month, as metered for a specific unit (e.g., a house or an apartment) associated with the user account. The data records indicating the monthly consumption of electricity may further include data representing a billed amount for the respective monthly consumption of electricity. Each billed amount, in monetary value, is also a form of resource consumption as the user makes one or more payments based on the billed amount for the consumed electricity.

The data records representing the monthly resource consumption of electricity and/or the monthly payment for the resource consumption of electricity, may be processed by the resource application, for instance using a machine learning architecture 300, to generate prospective data records representing prospective resource allocations for a predicted future point in time. The prospective resource allocation may include a predicted resource consumption of electricity, and/or a predicted resource consumption of payment for the predicted consumption of electricity. The generated data records for prospective resource allocations may be stored in database 122, and may be transmitted to one or more external systems such as external resource server 170. In the case of prediction of electricity consumption, external resource server 170 may be owned or managed by the electricity provider.

User device 130 may be a computing device, such as a mobile smartphone device, a tablet device, a personal computer device, or a thin-client device. User device 130 may be configured to operate with system 100 for executing data processes to display forecasted or prospective resource allocations for display at a user interface. As will be described in the present disclosure, other operations may be conducted by the user device 130.

User device 130 may include a processor, a memory, or a communication interface, similar to the example processor, memory, or communication interfaces of system 100. In some embodiments, user device 130 may be a computing device associated with a local area network. User device 130 may be connected to the local area network and may transmit one or more data sets to system 100.

Data source device 160 may be a computing device, such as a data server, a database device, or other data storing system associated with resource transaction entities. For example, data source device 160 may be associated with a banking institution providing banking accounts to users. The banking institutions may maintain bank account data sets associated with users associated with user devices 130, and the bank account data sets may be a record of monetary transactions representing credits (e.g., salary payroll payments, etc.) or debits (e.g., payments from the user's bank account to a vendor's bank account).

For example, data source device 160 may be associated with a vehicle manufacturer that has leased a vehicle to a user associated with user device 130. Data source device 160 may be, in this case, a computer device installed as part of the vehicle, or as an accessory of the vehicle. The data records from data source device 160 may include, for instance, data representing periodic consumption of gas or electricity, and other data related to operation of the vehicle.

In another example, data source device 160 may be associated with a vehicle manufacturer providing resource credit to a user associated with the user device 130. Terms of the resource credit may include periodic and recurring payments from a resource pool associated with the user (of the user device 130) to a resource pool associated with the vehicle manufacturer.

In some embodiments, system 100 may be configured to conduct operations for dynamically or adaptively determining projected resource availability (e.g., resource liquidity position) based on the forecasted prospective resource allocations associated with the user of user device 130.

In some embodiments, system 100 described in the present disclosure may include machine learning architecture 300 having machine learning models 110, 220 for generating forecasts of prospective resource allocations associated with a future point in time. In some situations, machine learning architecture 300 may generate outputs that are provided as input to downstream operations, thereby reduce occurrences of a resource pool (e.g., bank account) being overdrawn or having insufficient resources (e.g., lack of monetary funds) for prospectively forecasted resource allocations. The prospectively forecasted resource allocations may be based on trained machine learning models.

In some embodiments, based on the generated prospective data records representing prospective resource allocation(s), one or more control options may be generated and displayed by system 100 to a user to manage the resource consumption. For example, the control options, which can be generated by resource interface application 116, may allow the user to pre-emptively change, limit or otherwise configure (or control) the resource consumption in view of the generated prospective resource allocation, with one or more user input including a value for a user-adjustable parameter. Resource interface application 116 may generate and route the control commands based on the received user input to cause another system or server, either internal or external, to implement the user-specified changes, limits or configurations of the resource consumption.

In some embodiments, machine learning architecture 300 may be trained based on a sequence of data records representing prior resource allocations. For example, the sequence of data records may be a data set representing a sequence of transactions from a user account to a particular resource account. A resource account in this case may be a payee account associated with a party that receives payment from the user account, for example, a utilities provider account that receives payment for monthly electricity consumption. Respective data records representing a transaction may include a date and a resource amount value. To illustrate, a data record in the form of a data set, may include:
Account: XXX326
Payee: HYDRO QUEBEC
2020-01-08, $209.33
2020-02-16, $470.01
2020-04-26, $287.54
2020-06-11, $194.23
2020-08-17, $165.72
2020-10-12, $158.47
2020-12-31, $237.91
2021-04-25, $337.07
2021-06-24, $213.72
2021-09-03, $211.25
2021-10-24, $151.79
2021-12-27, $229.41

In some embodiments, machine learning architecture 300 may be trained based on one or more data records or data sets, where machine learning architecture 300 training operations may be performed without regard to external or auxiliary data sets about the user or a prospective/intended payee (e.g., an utility provider).

In some embodiments, an input data set may be retrieved from one or more data source devices 160 or external resource server 170. For example, data source device 160 may be an enterprise data warehouse (EDW) associated with structured query language (SQL) data structures. Other examples of data source devices 160 and associated structures may be contemplated.

In some embodiments, system 100 may include operations for pre-processing input data sets. Pre-processed input data sets may be configured for training embodiments of machine learning architecture 300 for generating forecasts of prospective resource allocations for particular users at a future point in time.

In some example embodiments, an input set of data records representing a sequence of transactions may be from a user account for a particular resource account. The user account may be associated with a first identifier (“user account ID”), and the resource account may be associated with a second identifier (“resource account ID”). The resource account may be associated with a payee name, e.g., HYDRO QUEBEC.

Data records from data source device 160 may include multiple data records or data sets from multiple dates. The data records may include records representing historical resource allocation to different resource accounts. The received data records may be pre-processed based on one or more key words to generate specific historical records associated with one or more resource accounts. For example, a specific group key in the data records may be used to filter out data sets in a corresponding payment configuration associated with the group key, where the group key may be a value or string representing a resource account, a type of payment, or a type of payment vehicle (e.g., debit transaction or credit card transaction). Generally speaking, pre-processing of the retrieved data records may generate one or more data sets based on one or more criteria, including but not limited to data sets associated with a single resource account within a specific range of time (e.g., in the past six months), as elaborated below.

The received data records may be pre-processed to generate one or more data sets representing a sequences of resource consumption events. A sequence of transactions is an example of a sequences of resource consumption events. A sequence of resource consumption events or transactions is defined to be a sequence of resource consumption events or transactions associated with (e.g., from) the same user account. In some embodiments, a sequence of resource consumption events or transactions is defined to be a sequence of resource consumption events or transactions associated with the same user account and the same resource account, each with a respective identifier.

When two data sets from the same user account are associated with different resource accounts, different resource account IDs, or different payee names (e.g. HYDRO QUEBEC, TORONTO HYDRO), then the two payments will be deemed to be in different groups or sequences. Each input set of data records is therefore associated with a first identifier and a second identifier, as being a sequence of transactions, in the form of a sequence of data sets, or prior resource applications between a user account and a specific resource account.

System 100 may include one or more operations of an input pre-processing pipeline. Example operations may include one or more of:
1. reducing transactions made on the same day in the same sequence into a single transaction;
2. remove sequences that consist of only a single transaction; and/or
3. for each sequence, extract the maximum transaction amount and normalize by a value associated with the maximum transaction amount, e.g., dividing all resource allocation or transaction amounts by the maximum transaction amount. This maximum transaction amount is stored, so that the normalization can be reversed at inference time, which is the time the trained machine learning architecture 300 is put into action on a set of input data to compute predicted output.

Other examples of pre-processing input data sets may be used.

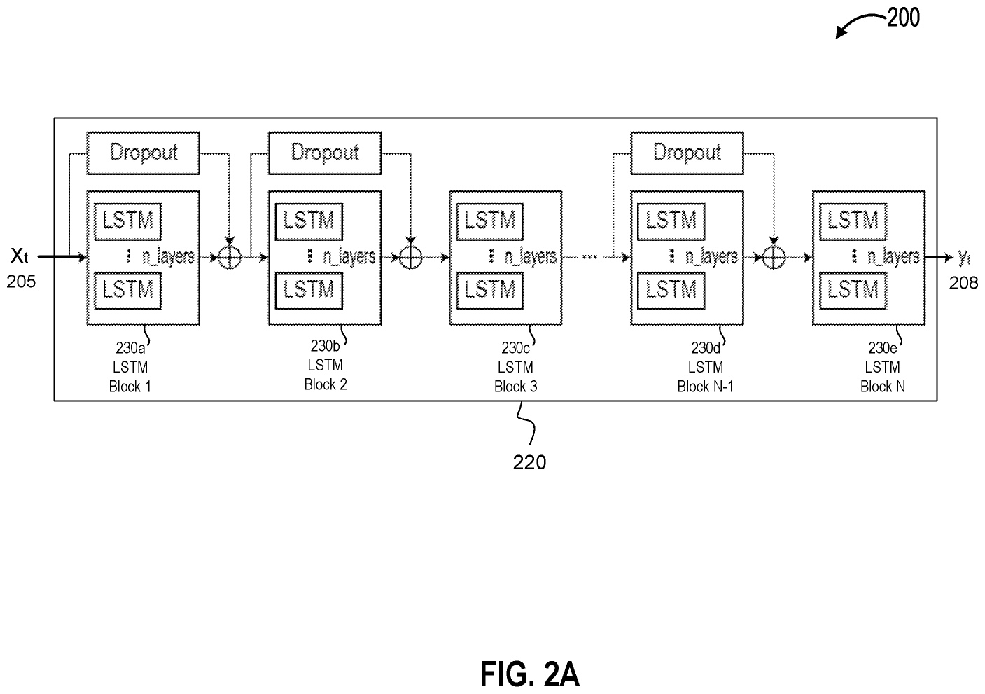

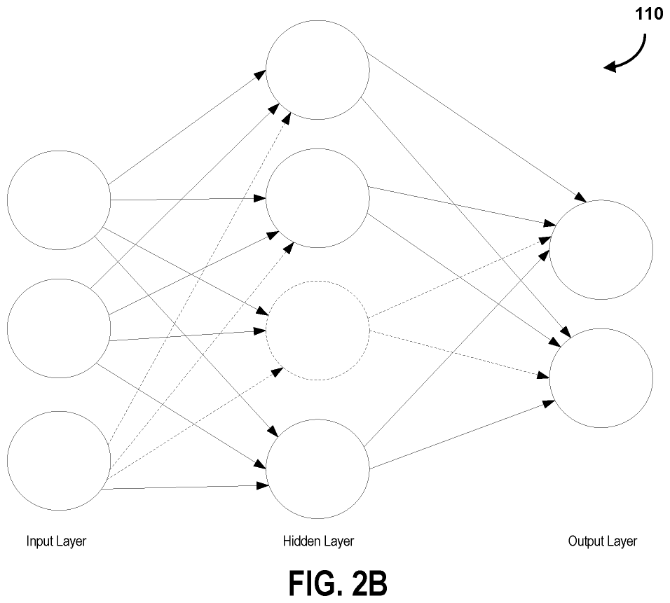

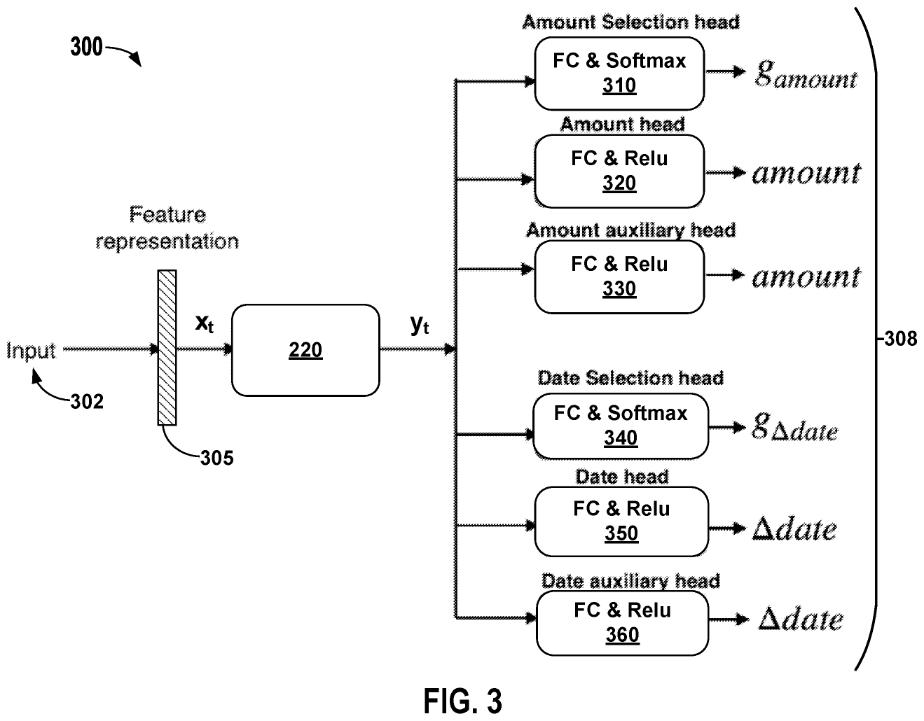

Reference is made to FIG. 3, which illustrates a block diagram showing a machine learning architecture 300 including a selective residual LSTM network 220, in accordance with embodiments of the present disclosure. FIG. 2A shows a block diagram 200 of a residual long short-term memory (LSTM) network 220 that may be implemented as part of machine learning architecture 300. In some embodiments, the residual LSTM 220 includes one or more blocks 230a, 230b, 230c, 230d, 230e of stacked LSTMs with residual connections between blocks. LSTM network 220 may receive an input Xₜ 205 and generate an intermediate output yₜ 208, as further elaborated below.

FIG. 2B is a schematic diagram of an example neural network 110, in accordance with an embodiment. The example neural network 110 can include an input layer, one or more hidden layers, and an output layer. An input layer may include units representing the input fields. The neural network 110 processes input data using its layers based on weights. The neural network 110 may be implemented to form a component or a part of LSTM network 220 or machine learning architecture 300.

In some embodiments, resource application 112 of system 100 may be implemented to perform one or more feature extraction operations for deriving input features from input 302, which may include data sets, representing one or more sequences of transactions or resource consumption events, generated by system 100 based on pre-processing of retrieved data records. For example, one or more input features identified from data sets representing a sequence of transactions or resource consumption events may include, for each respective transaction or resource consumption event:
The date-delta (e.g., number of days between a transaction date of the respective transaction and a transaction date of an immediately preceding transaction);
The normalized amount, which may be normalized by a predetermined value or a maximum transaction value as described above;
The day of the month;
The day of the week;
The total number of transactions in the sequence of transactions with a date in the same calendar period (e.g., same week or month) as the respective transaction, referred to as “the period of the respective transaction”; and/or
The total number of transactions in the sequence of transactions with a date in a one or more earlier periods immediately preceding the period of the respective transaction.

In some embodiments, one or more input features generated by resource application 112 can be represented in vector form using one-hot encoding. For instance, if the day of the week is Monday, it may be represented as [1, 0, 0, 0, 0, 0, 0], if the day of the week is Tuesday, it may be represented as [0, 1, 0, 0, 0, 0, 0], . . . , if the day of the week is Sunday, it may be represented as [0, 0, 0, 0, 0, 0, 1].

A feature representation represented by Xₜ 205 (or Xₜ 305 in FIG. 3), is generated by resource application 112 by concatenating input features obtained from feature extraction operations of resource application 112 performed on input data 302. The feature representation Xₜ 205, 305 may be generated by a feature extraction model of resource application 112.

As a non-limiting example of electricity consumption prediction, example input features obtained from feature extraction operations of resource application 112 for one particular consumption event or transaction may be obtained based on a sequence of data records, which may include monthly consumption of electricity with the latest billing date on Monday, Aug. 31, 2023. A simplified set of data records is shown below, which may be obtained after pre-processing of raw data records.

| | Electricity Usage | Total Charges |
|---|---|---|
| Date | in kWh | in CAD |
| 30 Apr. 2023 | 865 | 165 |
| 31 May 2023 | 783 | 152 |
| 30 Jun. 2023 | 739 | 150 |
| 30 Jul. 2023 | 678 | 130 |
| 31 Aug. 2023 | 689 | 135 |

Based on the data records above, example input features obtained from feature extraction operations of resource application 112 may be generated and processed to predict next month's electricity usage for a user, or a group of users. Such input features may include:
INPUT FEATURE 1: date delta: 32;
INPUT FEATURE 2: normalized amount: 0.8;
INPUT FEATURE 3: day of the month: 31;
INPUT FEATURE 4: day of the week: [0, 0, 0, 1, 0, 0, 0], which represents Thursday using one-hot encoding; and
INPUT FEATURE 5: the total number of transactions in the sequence of transactions in a defined calendar period including July and August: [1, 1].

Concatenated all five input features together in the above example, feature representation Xₜ 205, 305 is then [[32], [0.8], [31], [0, 0, 0, 1, 0, 0, 0], [1, 1]].

When the processed data records include corresponding charges for each billing period as shown above in column 3 for each period of electricity consumption, two instances of the machine learning architecture 300 may be executed at inference time to predict 1) amount of electricity consumption in kWh at a first future date and 2) a corresponding charge for the predicted amount of electricity consumption. The predictions may be generated for a user, a household, or a group of users or households. In areas where electricity consumption tends to vary depending on the season and other factors, the output of the system 100 can aid the electricity provider or consumer with actionable intelligence.

For instance, when a user of system 100 learns that the predicted electricity consumption for next month may be higher than expected, and will incur higher charges than the previous months, he or she may, via user input to user device 130 which are routed to system 100, trigger resource interface application 116 to generate and transmit one or more commands to set user-adjustable parameters in order to lower energy consumption. In addition or alternatively, user input received from user device 130 by system 100 may be processed by resource interface application 116 to set up a one-time automatic money transfer, prior to or by the predicted date for when the predicted charge is due, from a bank account (e.g., a savings account) to the account in which the payment is to be made (e.g., a chequing account) for the predicted charge.

As another non-limiting example, example input features obtained from feature extraction operations of resource application 112 for one particular resource consumption event or transaction Tx on Tuesday, Nov. 15, 2022 may include:
INPUT FEATURE 1: date delta: 14;
INPUT FEATURE 2: normalized amount: 0.6;
INPUT FEATURE 3: day of the month: 15;
INPUT FEATURE 4: day of the week: [0, 1, 0, 0, 0, 0, 0], which represents Tuesday using one-hot encoding; and
INPUT FEATURE 5: the total number of transactions in the sequence of transactions with a date in October (i.e., the calendar month before date of transaction Tx) and November: Oct 1, Oct 15, Oct 31, Nov 1, Nov 15, which can be represented as [1, 2, 3, 1, 2].

In some embodiments, the total number of transactions in the sequence of transactions with a date in a defined calendar period of the respective transaction may be a vector written as [1, 2, . . . m, 1, 2, . . . n], where m is the total number of transactions in the previous month (e.g., October), and n is the number of transactions in the month of this transaction (e.g., November). So in the non-limiting example above, the total number of transactions in the sequence of transactions with a date in a defined calendar period of the respective transaction can be represented as [1, 2, 3, 1, 2].

In some other embodiments, the total number of transactions in the sequence of transactions with a date in a defined calendar period of the respective transaction may be a vector, where each element in the vector has a value corresponding to a number of transactions in a respective sub-period of the defined calendar period. For instance, if the defined calendar period includes October and November as in the example above, the vector may be written as [3, 2].

Concatenated all input features one to five together, feature representation Xₜ 205, 305 for the above example is then [[14], [0.6], [15], [0, 1, 0, 0, 0, 0, 0], [1, 2, 3, 1, 2]]. This is a non-limiting example of feature representation Xₜ 205, 305.

In some embodiments, selective residual LSTM network 220 may be a double selective model architecture. Input 302 may be pre-processed, including feature extraction, to generate input features, which are concatenated together as a feature representation Xₜ 205, 305. At inference time, Xₜ is sent to selective residual LSTM network 220 to generate a preliminary or intermediate output yₜ 208, 308. Selective residual LSTM network 220 may include, or be connected to multiple output 310, 230, 330, 340, 350, 360, which may be referred to as output heads (or prediction heads) to, based on yₜ 208, 308, compute a plurality of final output 308 which may include the forecasted resource allocations and a predicted timing (e.g., a predicted date) for each forecasted resource allocation.

For instance, selective residual LSTM network 220 may include or be connected to six output heads, as shown in FIG. 3, including for example: an amount selection head 310, an amount prediction head 320, an auxiliary amount prediction head 330, a date selection head 340, a date prediction head 350, and an auxiliary date prediction head 360.

As shown in FIG. 3, the amount selection head 310 may be implemented via fully connected layers and a softmax function, which normalizes the output to a probability distribution over a set of output classes. Each of the amount prediction head 320 and the auxiliary amount prediction head 330 may be implemented via fully connected layers and a Rectified Linear Unit (ReLU). Similarly, the date selection head 340 may be implemented via fully connected layers and a softmax function, and each of the date prediction head 350 and the auxiliary date prediction head 360 may be implemented via fully connected layers and ReLU.

In some embodiments, machine learning architecture 300 may be configured to generate outputs at successive time steps (e.g., following respective resource allocation transactions in a sequence). The plurality of output 308 may include predicted normalized amount for one or more of: a predicted head amount from the amount prediction head 320, a predicted auxiliary amount from the auxiliary amount prediction head 330, an amount selection score from the amount selection head 310, a predicted head date-delta from the date prediction head 350, a predicted auxiliary date-delta from the auxiliary date prediction head 360, and a date selection score from the date selection head 340. The date-delta generally means the number of days between two consecutive transactions in the data records for the same user account and the same resource account, which may be determined based on a historical transaction in historical data records and a predicted data record, or may be between two historical transactions in historical data records. Once a date-delta amount has been determined, based on a last payment date in the most recent transaction, system 100 may generate a forecasted payment date by adding the date-delta to the last payment date.

In some embodiments, the auxiliary prediction values, such as the predicted auxiliary amount and the predicted auxiliary date-delta, may be provided for machine learning operations, for generating an auxiliary loss value, which is further described below in connection with loss functions of machine learning architecture 300.

In some situations, the resource application 112 having machine learning model architecture 300 may generate forecasted resource allocation values that may be coarse grain values (e.g., predicted monetary transaction amounts rounded to the nearest dollar). Such forecasted resource allocation values may be based on observed outlier input data record values. It may be beneficial to provide machine learning models for generating forecasted resource allocation values with greater precision, thereby facilitating downstream operations such as auto-population of forecasted resource allocation values.

Empirically, it is observed that recurring amounts of a set of data records associated with one resource account may lead to a prediction of inaccurate amount, as selective residual LSTM network 220 may be influenced by outlier amounts in the set of data records. In some examples, systems may be configured to conduct “snapping” operations, such as “snapping the predicted amount to the closest previously observed amount with at least N occurrences” or “snapping the predicted amount to the previous amount if the relative differences is less than X %”. In some situations, the above-described operations may be otherwise influenced by outlier input data set records.

It may be beneficial to configure machine learning models by guiding embodiments of the LSTM networks to predict forecasted resource allocation transactions with increased precision. In examples where the resource may be currency, it may be beneficial to configure machine learning models to predict forecasted resource allocation values with precision to a nearest cent (e.g., 1/100^{th} of a dollar).

In some embodiments, system 100 may be implemented to conduct operations associated with self-attention, thereby enabling machine learning architecture 300 at inference time to forecast resource allocation transactions with increased accuracy. In some embodiments, operations for self-attention may relate different positions within a single sequence of data records. Such operations may be related to operations of a Transformer model in natural language processing.

In some embodiments, self-attention may be implemented with selective residual LSTM network 220 to make the predicted head amount a learned, dynamic weighted average of previous resource allocation values. For example, at a current time step t, the current LSTM output representation yₜ may be used as the query, then the LSTM output representations y₁ to yₜ₋₁ from time steps 1 to t−1 as the keys, and the predicted head amounts from time steps 2 to t as the values. The predicted head amount can be a weighted average of previously observed amounts, where the weights are determined by a similarity of the current time step's LSTM output representation yₜ to the LSTM output representation from previous time steps 1 to t−1. In some examples, such operations may be related to operations of query-key-value attention.

The predicted head amount and LSTM output representations yₜ can be used without additional projections. To control the sharpness of the softmax outputs (i.e. the similarity scores) without learned projections, the scaling factor in the softmax can be made learnable instead of fixed, for example, the scaling factor can be interpreted as a temperature parameter. This learnable parameter allows the sharpness of the similarity scores to be driven by the network loss of selective residual LSTM network 220.

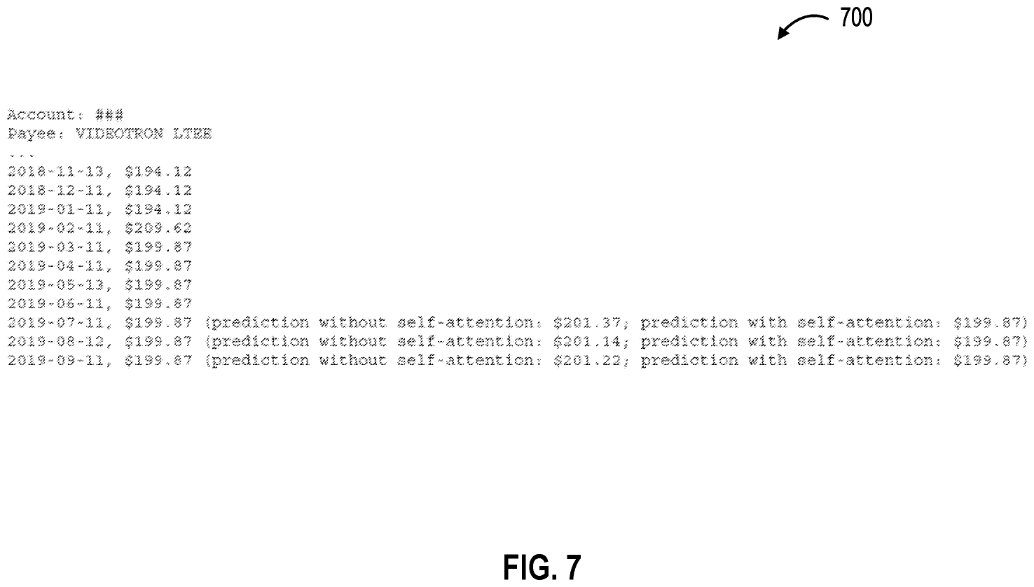

FIG. 7 shows an example set of data records 700 associated with a payee amount with the effect of self-attention. As shown, while the predicted head amounts with self attention is $199.87 for the last three predicted payment dates, the predicted head amounts without self-attention for the same dates fall somewhere between $201.14 to $201.37, which is a greater deviation from the historical payment amounts in the last four months.

In some embodiments, selective residual LSTM network 220 may be dynamic and may adapt to an actual payment behaviour of a user. As an example, selective residual LSTM network 220 may automatically or pre-emptively adjust to unexpected one-off resource allocation transactions or newly emerging resource allocation transaction patterns.

In some embodiments, one or both of the amount selection score and the date selection score may be dynamically determined, such that selective residual LSTM network 220 may be configured to continuously re-evaluate whether data set inputs or machine learning model outputs may predict prospective resource allocations for future points in time with sufficiently high confidence beyond a threshold value.

In some examples, machine learning architecture 300 may be implemented and trained to generate forecasted data for resource allocation. For example, machine learning architecture 300 may be implemented to generate a predicted amount and consumption date for electricity usage for one or more households at a future point in time, based on a sequence of historical data records. Each historical data record may include electricity consumption at a particular user location at a specific point in time in the past. Based on a sequence of such historical data records, the system may generate a prediction for peak electricity consumption at a predicted date, a corresponding first selection score indicating if the predicted electricity consumption is likely a valid prediction, and a corresponding second selection score indicating if the predicted date is likely a valid prediction. When either or both of the first and second selection scores is(are) above a minimum threshold, the predicted peak electricity consumption and/or a predicted date may be used for downstream processing, such as, for example, displaying at a electronic device, or used by the electricity provider for planning purposes.

In some examples, machine learning architecture 300 may be implemented and trained to generate forecasted data for weather forecasting. For example, machine learning architecture 300 may be implemented to generate a prediction for snowfall amount for a geographical location (e.g., Toronto) at a predicted date, based on a sequence of historical data records. Each historical data record may include snowfall at the same geographical location at a specific point in time in the past. Based on a sequence of such historical data records in a past month or season, the system may generate a prediction for peak snowfall at the predicted date (e.g., a three days from present), a corresponding first selection score indicating if the predicted snowfall is likely a valid prediction, and a corresponding second selection score indicating if the predicted date is likely a valid prediction. When either or both of the first and second selection scores is(are) above a minimum threshold, the predicted rainfall amount and/or predicted date may be used for downstream processing, such as, for example, issuing an electronic warning notifying weather station management regarding a potential snowfall that may be close to or above a peak amount.

In some examples, machine learning architecture 300 may be implemented and trained to generate forecasted data for property valuation. For example, machine learning architecture 300 may be implemented to generate a prediction for a market value for a property at a predicted date, based on a sequence of historical data records. Each historical data record may include market price for the same house or a similar house in the neighborhood at a specific point in time in the past. Based on a sequence of such historical data records, the system may generate a prediction for the market value for a property at a future point in time (e.g., the predicted date), a corresponding first selection score indicating if the predicted market value is likely a valid prediction, and a corresponding second selection score indicating if the predicted date is likely a valid prediction. When either or both of the first and second selection scores is(are) above a minimum threshold, the predicted market value and/or predicted date may be used for downstream processing, such as, for example, displaying at a electronic device, or used by mortgage providers for providing loans and mortgages for purchasing said house.

In some examples, machine learning architecture 300 may be implemented and trained to generate forecasted data for inventory allocation. For example, machine learning architecture 300 may be implemented to generate a prediction for an amount of purchase orders for a certain product or a certain type of products at a predicted date, based on a sequence of historical data records. Each historical data record may include past purchase order amounts for the same product or same type of products at a specific point in time in the past. Based on a sequence of such historical data records, the system may generate a prediction for an amount of purchase orders for the product or the specific type of products at the predicted date, a first corresponding selection score indicating if the predicted amount of purchase orders is likely a valid prediction, and a corresponding second selection score indicating if the predicted date is likely a valid prediction. When either or both of the first and second selection scores is(are) above a minimum threshold, the predicted amount of purchase orders and/or predicted date may be used for downstream processing, such as, for example, displaying at a electronic device, or used by retailers or manufactures for planning purposes.

In some embodiments, the generated plurality of output 308, may be provided as inputs to downstream applications. The output may be raw or unaltered machine learning model outputs when provided to a downstream application. The downstream operations may interface with machine learning architecture 300 via application programmable interfaces (APIs). Other operations for interfacing with machine learning architecture 300 may be used.

For example, UI display module 114 may interface with resource application 112 including machine learning architecture 300 to generate one or more signals for rendering one or more graphical user elements and data values for display at user device 130 based on the plurality of output 308. For another example, resource interface application 116 may interface with machine learning architecture 300 to generate one or more commands including appropriate data values for external resource servers or applications 170 based on the plurality of output 308.

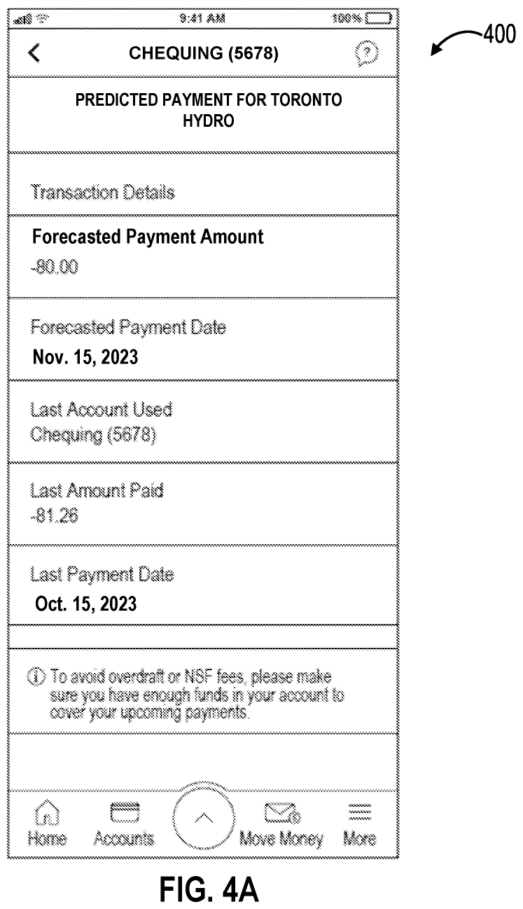

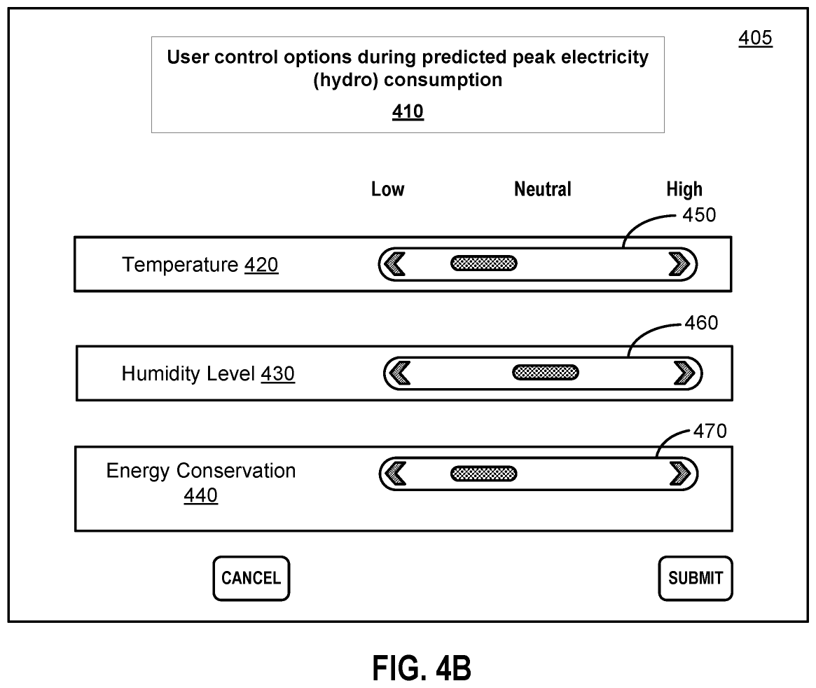

FIG. 4A illustrates an example user interface 400 associated with displaying forecasts of prospective resource allocations associated with a predicted payment date, in accordance with embodiments of the present disclosure. The user interfaces may be associated with a user account (e.g., a bank account), and the user interfaces may be application landing pages associated with the resource application 112 (FIG. 1), as rendered by UI display module 114. In this case, the forecasted payment amount is 80.00 dollars, and the forecasted payment date is Oct. 15, 2023. The forecasted resource allocation and forecasted payment date may be generated by machine learning architecture 300 implemented by system 100, and facilitates downstream operation by system 100 or by the user.

For example, an automatic amount, which may be set by resource application 112 or another component of system 100, to be transferred from a different bank account associated with the user account to the bank account that is configured to make the payment for the forecasted payment account, on a date that is at least a few (e.g., three to five) business days prior to the forecasted payment date.

FIG. 4B illustrates an example user interfaces 405 for displaying user control options 410 for a resource consumption, which in this case, is consumption of electricity. Based on the generated prospective data records representing prospective resource allocation(s) in output 308, which has been generated by ML architecture 300 in resource application 112, one or more control options may be generated and displayed by system 100 to a user to manage the resource consumption.

In some embodiments, system 100 may be interfaced or connected with an external server 170 from a utilities provider associated with the resource account in the data records used by system 100 to generate the prospective resource consumption or allocation. The external server 170 may process input data to aid with the management or operation of a heating, ventilation, and air conditioning (HVAC) system of a household belonging to the user associated with user device 130. Historical and real-time environmental and operating data of the HVAC system may be obtained from sensors in the house or a database, and routed by the external server 170 to system 100.

Based on data received from external server 170 and the generated prospective data records representing prospective resource allocation(s) in output 308 from resource application 112, control options can be generated by resource interface application 116, which may allow the user to pre-emptively change, limit or otherwise configure (or control) the resource consumption in view of the generated prospective resource allocation, with one or more user input including a value for a user-adjustable parameter. One or more resource consumption control options including one or more user-adjustable parameters may be generated by system 100, and caused to render at user device 130.

Referring back to FIG. 4B, three graphical user interface (GUI) elements showing user-adjustable parameters 420, 430, 440 are displayed to user at user device 130, each including a respective UI element 450, 460, 470 such as a slider or scroll bar, for indicating a relative level of preference or control. For example, moving the scroll button within scroll bar 450 to the left may indicate relatively low importance or preference for the user-adjustable parameter “temperature” 420. Similarly, moving the scroll button within scroll bar 450 to the right may indicate a relatively high importance or preference for the user-adjustable parameter “temperature” 420. Moving the scroll button within scroll bar 450 to the middle may indicate a neutral importance or preference for the user-adjustable parameter “temperature” 420. Similarly, the preferences can be set for other user-adjustable parameter such as “humidity level” 430 and “energy conservation” 440 using respective scroll button within each scroll bar 460, 470. Other GUI elements may be used to display control options, user-adjustable parameters, and other data.

Once a user is satisfied with the entered user-adjustable parameters, he or she may proceed to click the “submit” button. Alternatively, the user may cancel the user input and re-start the process.

Resource interface application 116 may further generate and route the control commands based on the received user input from UI 405 to cause external server 170 to implement the user-specified changes, limits or configurations of the resource consumption.

### Training of Machine Learning Network

In some embodiments, to increase efficiency of machine learning training operations, system 100 may be configured to randomly sample a subset of user data records associated with user accounts. In some embodiments, system 100 may train machine learning architecture 300 using an ADAM optimizer.

In some embodiments, selective residual LSTM network 220 in machine learning architecture 300 described in the present disclosure may have an overall or base loss L of selective residual LSTM network 220, based on training data xᵢ, yᵢ, i=1 . . . m, where xᵢ represents input data and yᵢ represents the corresponding ground truth label or ground truth data in each set of training data, in a total of m sets of training data. Selective residual LSTM network 220 may be denoted by a prediction function f: x→y, where input x is processed by selective residual LSTM network 220 to generate an output y.

L may be a convex combination of a selective amount prediction loss Lₐₘₜ and a selective date prediction loss L_{Δdate}. Lₐₘₜ may be determined based on a symmetric mean absolute percentage error (sMAPE) on the amounts. L_{Δdate} may be determined based on mean absolute error (MAE) on the date-deltas, a date-delta may also be written as Δdate. For example, the overall loss L can be generally expressed as weighted sum of selective amount prediction loss Lₐₘₜ and the selective date prediction loss L_{Δdate}, e.g.:

The overall loss is a weighted sum of amount loss Lₐₘₜ and date loss L_{Δdate}:

L=βLₐₘₜ+(1−β)L_{Δdate} (1)

where β is a weight.

The amount selective loss is the following:

Lₐₘₜ=αL_{(f,g)}_{ₐₘₜ}+(1−α)Lₕ_{ₐₘₜ} (2)

where L_{(f,g)}_{ₐₘₜ} is amount selective loss and Lₕ_{ₐₘₜ} is amount auxiliary loss. Similarly the date loss is:

L_{Δdate}=αL_{(f,g)}_{_{Δdata}}+(1−α)Lₕ_{_{Δdate}} (3)

where L_{(f,g)}_{_{date}} is date selective loss and Lₕ_{_{Δdate}} is date auxiliary loss. For simplicity, we omit the subscript amt and Δdate in the following equations: The selective loss can be expressed by:

$${L}_{( f , g )} Δ {=}^{△} {\hat{r}}_{t} ( f , g \vert {S}_{m} ) + λΨ ( c - \hat{Φ} ( g \vert {S}_{m} ) ) \qquad ( 4 )$$

$$Ψ ( a ) {=}^{△} {max ( 0 , a )}^{2} \qquad ( 5 )$$

$$where$$

$$\hat{r} ( f , g \vert {S}_{m} ) {=}^{△} \frac{\frac{1}{m} {\sum }_{i = 1}^{m} l ( f ( {x}_{i} , {y}_{i} ) g ( {x}_{i} )}{\hat{ϕ} ( g \vert {S}_{m} )} \qquad ( 6 )$$

is the selective empirical risk,

$$\hat{ϕ} ( g \vert {S}_{m} ) {=}^{△} \frac{1}{m} {\sum }_{i = 1}^{m} g ( {x}_{i} )$$

is the empirical coverage, f is the prediction function, g is the selection function, c is the target coverage. The above is the main equations of double selectiveNet.

In some embodiments, selective residual LSTM network 220 in machine learning architecture 300 described in the present disclosure may have a double selective prediction loss (or simply referred to as selective loss above) generally expressed as:

$${ℒ}_{( f , g )} {=}^{△} {\hat{r}}_{ℓ} ( f , g \vert {S}_{m} ) + λΨ ( c - \hat{ϕ} ( g \vert {S}_{m} ) )$$

$$Ψ ( a ) {=}^{△} max {( 0 , a )}^{2} ,$$

$$where$$

$$\hat{r} ( f , g \vert {S}_{m} ) {=}^{△} \frac{\frac{1}{m} {\sum }_{i = 1}^{m} ℓ ( f ( {x}_{i} ) , {y}_{i} ) g ( {x}_{i} )}{\hat{ϕ} ( g \vert {S}_{m} )}$$

may be the selective empirical risk, and

$$\hat{ϕ} ( g \vert {S}_{m} ) {=}^{△} \frac{1}{m} {\sum }_{i = 1}^{m} g ( {x}_{i} )$$

is be the empirical coverage, where f is the prediction function, g is the selection function, c is the target coverage, λ is a balancing hyper parameter, and ψ is a quadratic penalty function.

In some embodiments, system 100 may be configured such that the convex combination of a selective amount prediction loss Lₐₘₜ and a selective date prediction loss L_{Δdate} may be replaced with multi-task learning, which may adjust the fusion weights dynamically based on task difficulty or progress.

### Category Specific Selection for Double Selection

In some situations, a category of resource allocations (i.e. scheduled) are expected to be selected more (e.g. 90% of the time), and another category of resource allocations (i.e non-scheduled) are expected to be selected less frequently (e.g. 50% coverage for some descent accuracy).

There may be therefore a category specific loss for double selective residual LSTM network 220, with the category specific loss being a weighted sum for each specific category represented by equation (7) below:

$${L}_{( f , g )} {=}^{△} {\hat{r}}_{l} ( f , g \vert {S}_{m} ) + {\sum }_{k = 1}^{n} {λ}_{k} Ψ ( {c}_{k} 0 - Φ ( {g}_{k} \vert {S}_{{m}_{k}} ) ) \qquad ( 7 )$$

where k represents a respective category k out of n categories.

In some embodiments, double selective residual LSTM network 220 may be implemented to have two categories: e.g., a first category including scheduled data and a second category including non-scheduled data. The machine learning model remains the same for category specific and non-category specific training, with the only difference being the loss function. Mask can be used to differentiate scheduled data and non-scheduled data.

### Calibration

Selective networks trained at the same level of target coverage may differ in the actual coverage achieved in evaluation (i.e., the number of predictions made on the test set) due to distribution shift or random train-test variations. For a fair comparison, coverage calibration is applied to equalize the number of test predictions across all approaches. For example, when evaluating at a coverage level of 70%, error metrics over the 70% most confident predictions (highest g values) among the test samples are computed.

The appropriate threshold can be estimated via the following equations:
selection_threshold=np.percentilte(selected_df, 100−target_coverage*100)
Tau==selection_threshold

The decision rule is written as:

$$( f , {g}_{τ} \} ( x ) {=}^{△} \{ \begin{matrix}f ( x ) , & if g ( x ) \geq τ \\ don ' t know , & otherwise\end{matrix} .$$

date_selection_calibrated_threshold=self.get_calibration_threshold(events_df[m_c.SELECTION], self.calibration_date_target_coveraqe)
date_selected_df=events_df[events_df[selection_column]>=date_selection_calibrated_threshold]

In terms of evaluation metrics, sMAPE (symmetric mean absolute percentage error) is used to evaluate the performance of amount prediction:

$$sMAPE = \frac{100 \%}{m} {\sum }_{i = 1}^{m} \frac{\vert {y}_{i} - {\overline{y}}_{i} \vert}{( \vert {y}_{i} \vert + \vert {\overline{y}}_{i} \vert ) 1 / 2}$$

For date metric, MAE (mean absolute error) is used to evaluate the performance of date prediction:

$$M A E = \frac{1}{m} {\sum }_{i = 1}^{m} \vert {y}_{i} - {\overline{y}}_{i} \vert$$

where m represents a total number of iterations performed by the double selective residual LSTM network 220, yᵢ represents ground truth value, and y̅ᵢ represents predicted value in the iteration i.

Snap metric may be used to evaluate the amount prediction results for the selective residual LSTM network with self-attention. The snap metric calculates the percentage of exact prediction. if predicted amount (rounded in two decimal points)==ground truth amounts, it is a snap count: snap_metric=snap_counts/all_counts*100%.

Table 1 below shows main results for a machine learning architecture 300 including selective residual LSTM network 220.

TABLE 1

| | | date MAE | amount |
|---|---|---|---|
| | Coverage | (days) | sMAPE |
| scheduled data | 83% | 1.77 | 4.10% |
| non-scheduled data | 33% | 4.60 | 25.96% |

Table 2 below shows ablation study results for attention module with MVP data and snap metric.

TABLE 2

| Model | coverage | snap_metric |
|---|---|---|
| Double SelectiveNet | 90% | 0.3% |
| without attention | | |
| Double SelectiveNet | 90% | 78.3% |
| with attention | | |

Table 3 shows ablation study on the impact of training data, which shows an improvement when adding more training data. In this example, using about 8% of training data is the point where a good tradeoff is reached, and may be therefore set as a recommended procedure for training a neural network architecture by system 100.

TABLE 3

| | scheduled data | | | non-scheduled data | | |
|---|---|---|---|---|---|---|
| Training data | | date | amount | | date | amount |
| percentage | coverage | MAE | sMAPE | coverage | MAE | sMAPE |
| 0.5% | 79% | 1.75 | 3.61% | 23% | 4.36 | 11.34% |
| 2% | 80% | 1.91 | 3.38% | 25% | 4.68 | 12.23% |

In some embodiments, during machine learning training, loss contributions of respective input data records may be weighted by the selection score (e.g., multiple output of selective residual LSTM network 220 illustrated in FIG. 3). Based on features described with reference to FIG. 3, training a selective residual LSTM network 220 may: (i) teach the network 220 recognize when to abstain from conducting operations based on irregular sequences of data records; and/or (ii) configure the machine learning model 300 to focus conduct optimization operations based on subset of data records for which resource allocations may be made. In some embodiments, selective residual LSTM network 220 may be trained based on an integrated reject option.

In some embodiments, a first or second selection score, or both, may be generated based on an integrated reject option built into a machine learning model. A first selection score may be associated with the predicted amount and the second selection score may be associated with the predicted date.

Some prospective resource allocation transaction sequences may be challenging to predict. For example, some sequences of resource allocation transactions may have features representing infrequent bill payments for retailer credit cards, sequences with many missed or extra payments, or sequences with unclear billing intervals. With such sequences of data records representing prior resource allocation transactions, it may be challenging to train a machine learning model to reliably predict sequences of data records representing resource allocation transactions. Machine learning training operations based on such irregular sequences of data records may hinder machine learning models from training based on more optimal sequences of data records representing relatively stable or generalizable patterns of resource allocation transactions.

In some examples, system 100 may be configured to conduct manually created rules to define a subset of data records identified as regular or irregular. For example, manually created rules may include: “if the sequence of data records representing prior resource allocation transactions consists of more than X gaps of Y days, and the median gap is Z, then the sequence may be irregular”. However, such manually configured operations may not be scalable.

In some embodiments, system 100 may include machine learning architecture configured to conduct operations implementing a “reject option”. The example “reject option” may be a machine learning model output representing a decision to abstain from making a prediction based on data records that may be identified as uncertain.

In addition to determining usual prediction or forecasting targets (e.g. the date and amount of the next transaction), in some embodiments, machine learning models may be configured to conduct operations to include an integrated reject option, thereby learning to output a “selection” score for a corresponding predicted value, which may be the predicted amount or predicted date. A selection score may be a real-valued score to provide an indication on whether the machine learning model should abstain from making any predictions based on an identified sequence of data record input.

In some embodiments, a selection score may be a real-valued score, generated for a predicted value such as a predicted or prospective resource allocation amount, to provide an determination on whether the predicted or prospective resource allocation amount is a valid prediction. In cases where the selection score is higher than a minimum threshold, the corresponding predicted or prospective resource allocation amount may be stored as a valid prediction and presented for display at a user device 130, or used for further operation.

Thus, machine learning models configured to conduct operations with a selection score may represent a balance among forecasting accuracy and input data set coverage (e.g., percentage of inputs for which the machine learning model may generate a prediction of a prospective resource allocation at a future point in time.

In some embodiments, the generated selection score may indicate whether a generated prediction of a prospective resource allocation be: (i) rejected or withheld; or (ii) be provided for display or for a downstream operation of example systems described herein. In some embodiments, a selective loss expression may penalize a machine learning network if a specific level of coverage is not met (e.g., predictions may be required to be made 40% of the time). In the present examples, methods thereby may not assume a particular parametric model for the data distribution, and may optimize for coverage directly and focus on more predictable data.

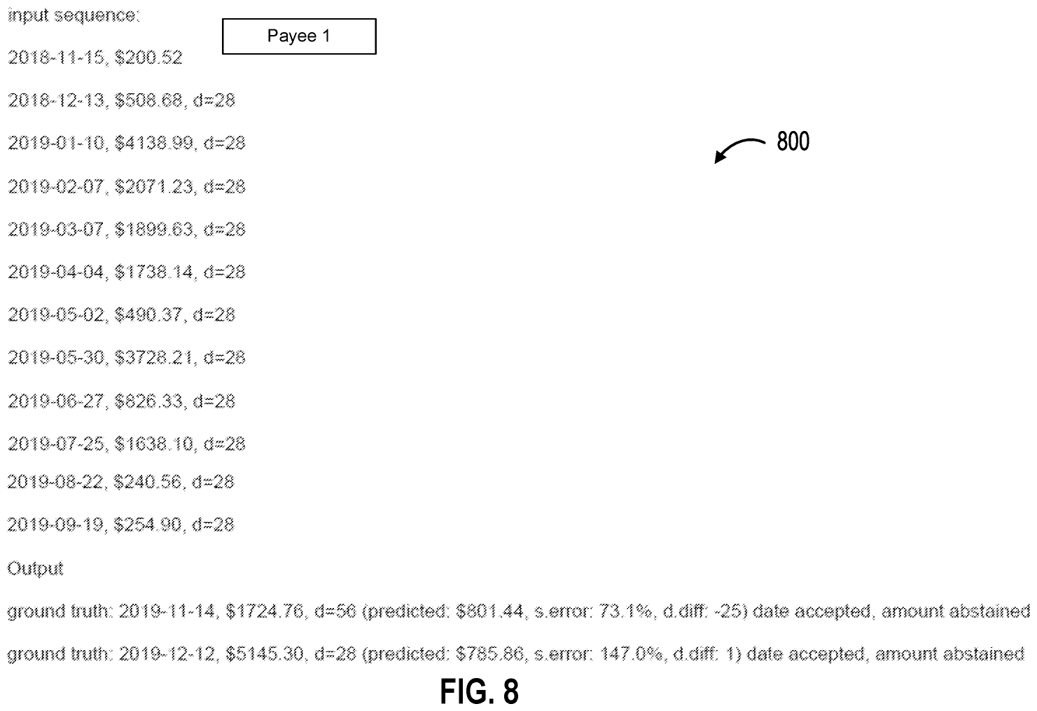

FIGS. 8 to 13 each shows an example set of data records from a respective resource account with respective training results for a machine learning architecture 300 trained by system 100. Throughout the following discussion: d is used to represent date_delta (the date difference between two consecutive resource allocations or transactions) in the qualitative examples; s.error is used to represent a sMAPE for amounts; and d.diff is used to represent the difference in dates between the predicted date and ground truth.

FIG. 8 shows that based on the historical data records 800, machine learning architecture 300 has generated two sets of output. The first set of output has a predicted amount of $801.44, s.error: 73.1%, and a d.diff of −25. The second set of output has a predicted amount of $785.86, s.error: 147.0%, and a d.diff of 1. For both sets of output, the respective predicted date was accepted by system 100, while the respective predicted amount was abstained or rejected. In some cases, the error value s.error may be generate based on the overall selective loss L and used to decide if a data record should be abstained from downstream operation.

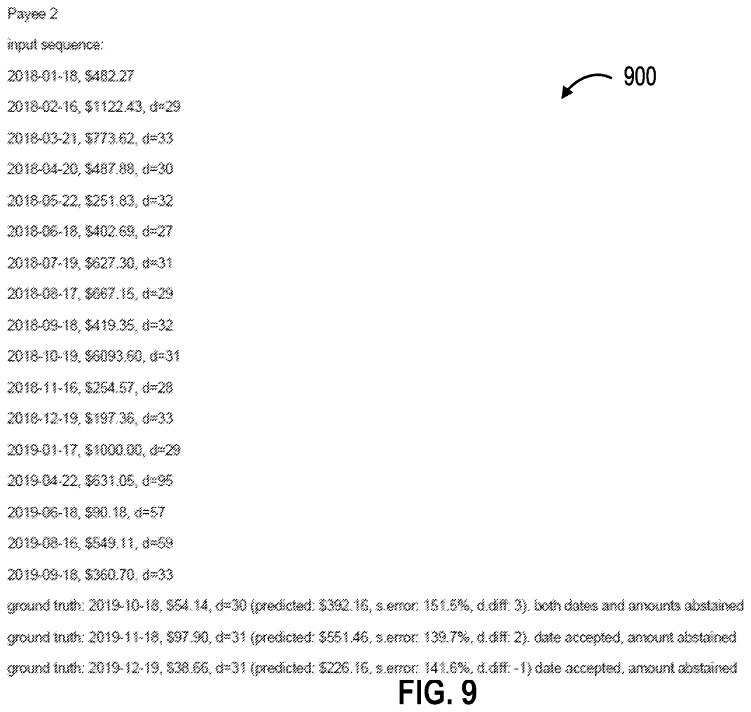

In FIG. 9, the historical data records 900 contains a plurality of regular dates (e.g. approximately monthly) and a plurality of irregular dates (e.g., date-delta is 95, 57 or 59 in irregular cases). The amounts in the historical data records 900 appear to be irregular. System 100 first rejects the predicted date and amount after processing the irregular historical data records associated with irregular dates as the most recent training data. As additional, more recent historical data records with regular date-delta have been processed as training data, system 100 has accepted the predicted dates and rejected the predicted amounts.

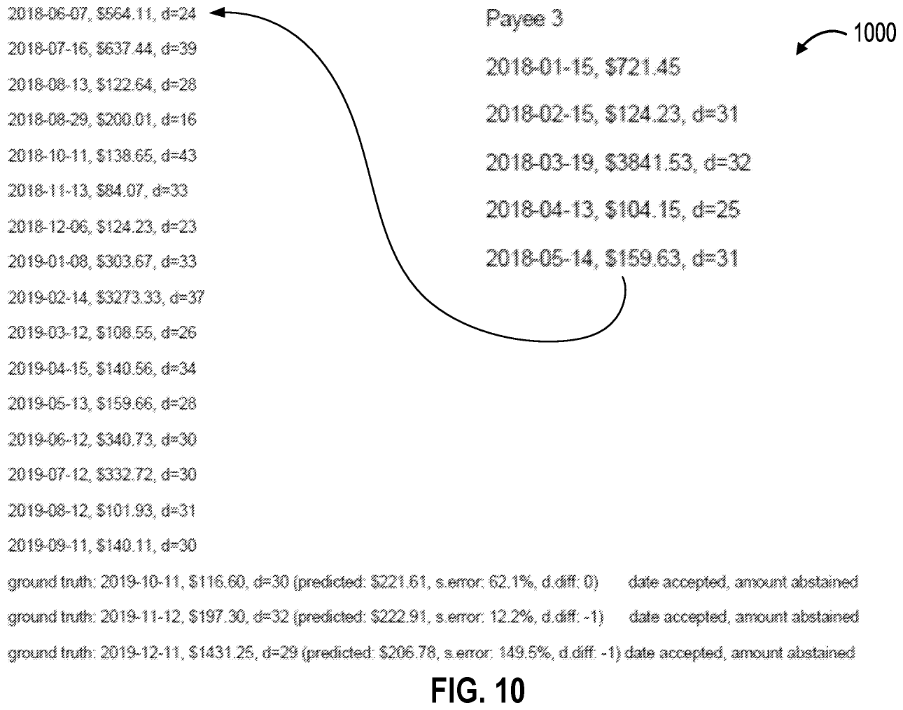

In FIG. 10, the historical data records 1000 appear to contain data records with regular dates (e.g. approximately monthly), while the associated amounts are irregular. System 100 has accepted the predicted dates and rejected the predicted amounts.

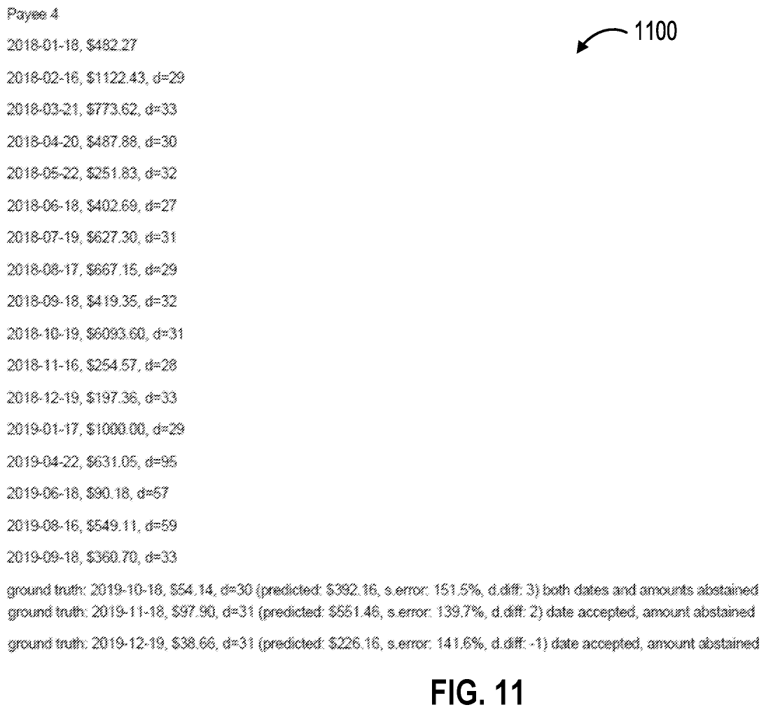

In FIG. 11, the historical data records 1100 appear to contain data records with a mix of regular and irregular dates, associated with irregular amounts. System 100 has accepted some predicted dates and rejected the predicted amounts.

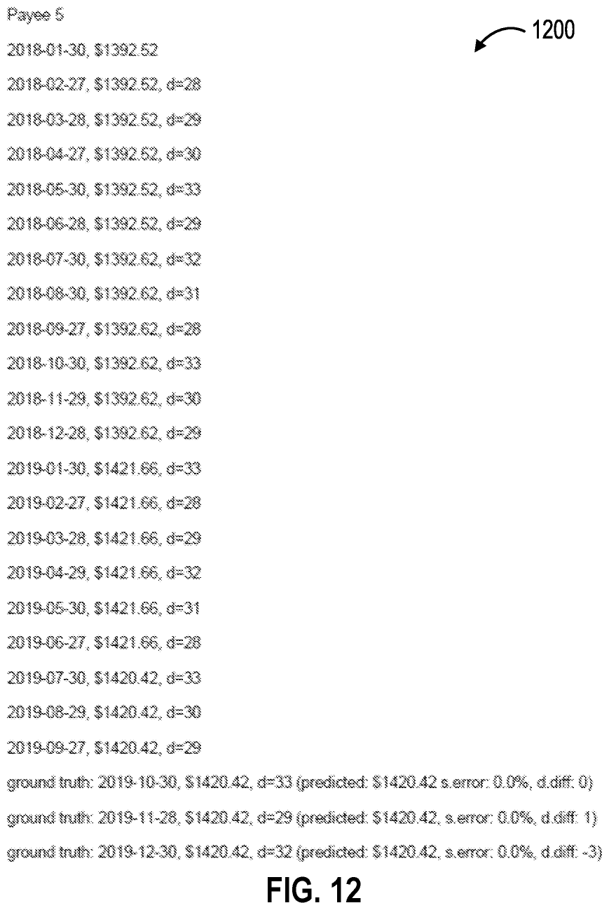

In FIG. 12, the historical data records 1200 appear to contain both regular dates and amounts, and system 100 has accepted both predicted dates and amounts in all three sets of output.

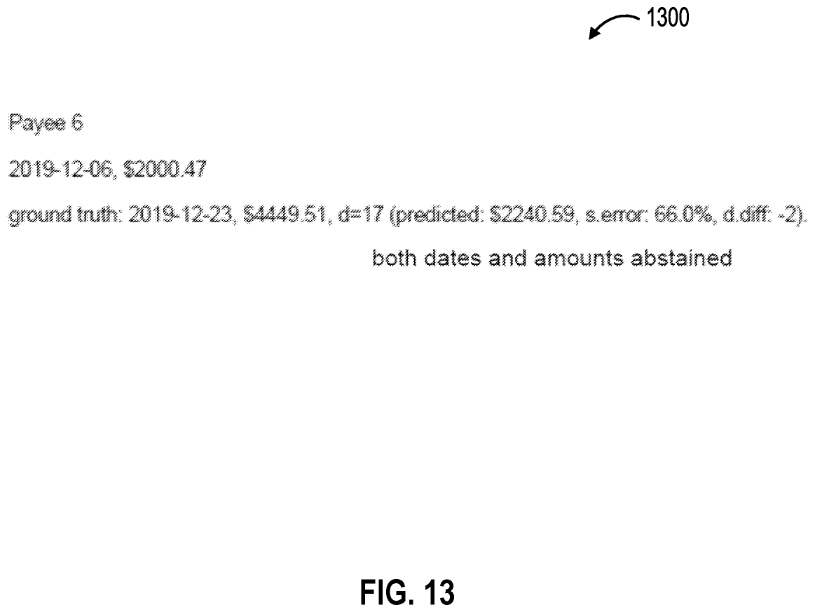

FIG. 13 shows a short sequence with only one transaction 1300. System 100, with only one historical data record, exhibited a low confidence score and has rejected both the predicted date and amount.

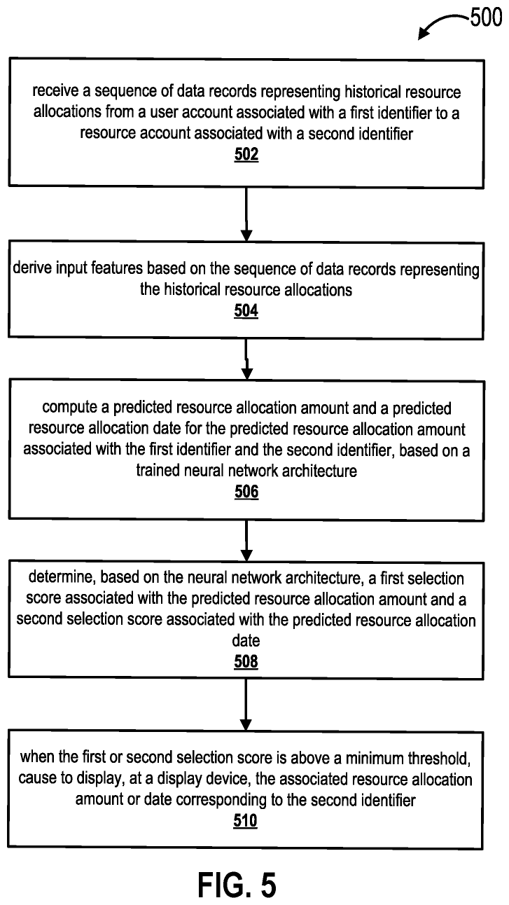

Reference is made to FIG. 5, which illustrates a method 500 of forecasting prospective resource allocations with corresponding dates, in accordance with embodiments of the present disclosure. Method 500 may be conducted by processor 104 of system 100. Processor-executable instructions may be stored in the memory 108, including resource application 112, UI display module 114, resource interface application 116, and other processor-executable applications not illustrated in FIG. 1. Method 500 may include operations such as data retrievals, data manipulations, data storage, or other operations, and may include computer-executable operations.

At operation 502, processor 104 may receive a sequence of data records representing historical resource allocations from a user associated with a first identifier to another user, such as a resource account, associated with a second identifier. A resource account may be referred to as a payee account when it is associated with a payment transaction. Respective data records may include a resource value, a date/time stamp, or other featured data value. The data records may include data sets representing periodic resource consumption of a resource, such as for instance, monthly consumption of electricity in the units of kW, or monthly payment for the resource consumption of electricity.

At operation 504, processor 104 may derive input features based on the sequence of data records representing the historical resource allocations. In some embodiments, input features may include identifying time intervals between successive and adjacent data records in the sequence. Other input features may be derived. In some embodiments, irregular input features may include identification or indication of irregular energy consumption events. For another example, irregular input features identified among the sequence of data records may include identification or indication of one or more data records representing infrequent bill payments for credit card accounts, one or more sequences of data records representing with several missed payments or extra payments, or one or more sequences of data records representing unclear billing intervals.

In some embodiments, processor 104, in accordance with instructions stored within resource application 112 of system 100, may be executed to perform one or more feature extraction operations for deriving input features from input 302, which may include data sets, representing one or more sequences of transactions or resource consumption events, generated by system 100 based on pre-processing of retrieved data records. For example, one or more input features identified from data sets representing a sequence of transactions or resource consumption events may include, for each respective transaction or resource consumption event:
The date-delta (e.g., number of days between a transaction date of the respective transaction and a transaction date of an immediately preceding transaction);
The normalized amount, which may be normalized by a predetermined value or a maximum transaction value as described above;
The day of the month;
The day of the week;
The total number of transactions in the sequence of transactions with a date in the same calendar period (e.g., same week or month) as the respective transaction; and/or
The total number of transactions in the sequence of transactions with a date in the calendar period immediately preceding the calendar period of the respective transaction.

In some embodiments, one or more input features generated by resource application 112 can be represented in vector form using one-hot encoding. For instance, if the day of the week is Monday, it may be represented as [1, 0, 0, 0, 0, 0, 0], if the day of the week is Tuesday, it may be represented as [0, 1, 0, 0, 0, 0, 0], . . . , if the day of the week is Sunday, it may be represented as [0, 0, 0, 0, 0, 0, 1].

A feature representation represented by Xₜ 205 (or Xₜ 305 in FIG. 3), is generated by resource application 112 by concatenating input features obtained from feature extraction operations of resource application 112 performed on input data 302. The feature representation Xₜ 205, 305 may be generated by a feature extraction model of resource application 112.

At operation 506, processor 104 may compute a predicted resource allocation amount and a predicted resource allocation date for the predicted resource allocation amount associated with the first identifier and the second identifier based on a trained neural network architecture and the derived input features. The neural network architecture may include a residual long short-term memory (LSTM) network 220 including blocks of stacked LSTMs with residual connections between blocks.

For example, a bill payment from a user named Bob to a hydro-electric company (e.g., Quebec Hydro) may be made on a monthly basis. In some examples, at operation 806, processor 104 may generate prospective resource allocations associated with the hydro-electric company (as payee). Other example prospective resource allocations may be used.

In some embodiments, based on the first or second selection score, processor 104 may associate a weight with an identified data record or a predicted date corresponding to an irregular record feature. In some examples, a zero weight being associated with the identified data record corresponding to the irregular record feature may be for abstaining from generating a prospective resource allocation.

The neural network architecture may, in some embodiments, include an integrated reject parameter for providing one or more selection scores.

In some embodiments, the neural network architecture is configured to generate one or more outputs associated with one or more time steps, the one or more outputs including a predicted head amount, a predicted auxiliary amount, an amount selection score, a predicted head date-delta, a predicted auxiliary date-delta, and a date selection score.

In some embodiments, the neural network architecture is trained based on the predicted auxiliary amount and the predicted auxiliary date-delta.

In some embodiments, a weight may be assigned to an identified data record corresponding to an irregular record feature.

In some embodiments, a zero weight may be assigned the identified data record corresponding to the irregular record feature for abstaining from generating a prospective resource allocation.

In some embodiments, an adjusted prospective resource allocation may be generated corresponding to the second identifier based on self-attention operations to provide the adjusted prospective resource allocations as being a dynamic weighted average of prior observed resource allocation values.

In some embodiments, processor 104 may conduct operations to abstain from generating the prospective resource allocation in response to an identified data record having an irregular feature or value. For example, processor 104 may determine whether to generate or to abstain from generating a prospective resource allocation amount or date, subsequent to a respective observation or time step corresponding to a sequence of data records. Processor 104 may abstain from generating the prospective resource allocation in response to identifying a data record having an irregular feature. Irregular features may be associated with infrequent resource allocations (e.g., infrequent bill payments), sequences of missed or sequences of extra payments, or sequences having unclear billing intervals. Other examples of irregular features or other examples of abstaining from generating prospective resources allocations may be contemplated.

In some embodiments, processor 104 may generate one or more adjusted prospective resource allocations corresponding to the second identifier based on self-attention operations, where the adjusted prospective resource allocations include a dynamic weighted average of prior observed resource allocation values.

In some embodiments, the neural network architecture may include a neural network model having a network loss including a selective prediction loss expressed as:

$${ℒ}_{( f , g )} {=}^{△} {\hat{r}}_{ℓ} ( f , g \vert {S}_{m} ) + λΨ ( c - \hat{ϕ} ( g \vert {S}_{m} ) )$$

$$Ψ ( a ) {=}^{△} max {( 0 , a )}^{2} ,$$

$$where$$

$$\hat{r} ( f , g \vert {S}_{m} ) {=}^{△} \frac{\frac{1}{m} {\sum }_{i = 1}^{m} ℓ ( f ( {x}_{i} ) , {y}_{i} ) g ( {x}_{i} )}{\hat{ϕ} ( g \vert {S}_{m} )}$$

is a selective empirical risk, and

$$\hat{ϕ} ( g \vert {S}_{m} ) {=}^{△} \frac{1}{m} {\sum }_{i = 1}^{m} g ( {x}_{i} )$$

is a empirical coverage, f is a prediction function, g is a selection function for generating the selection score, c is a target coverage, λ is a balancing hyper parameter, and ψ is a quadratic penalty function.

At operation 508, processor 104 may generate, based on the neural network architecture, a first selection score associated with the predicted resource allocation amount and a second selection score associated with the predicted resource allocation date. For example, the first or second selection score may be a real value between 0 and 1. A threshold may be set to 0.5 or another suitable value, and long as the selection value is above the threshold value, the associated prospective resource allocation may be stored as a valid prediction.

At operation 510, processor 104 may, when the first or second selection score is above a minimum threshold (e.g., 0.5), cause to display, at a display device (e.g., a display of the user device 130), the associated resource allocation amount or date corresponding to the second identifier.

For example, the resource allocation may be an allocation of purchase orders, allocation of electricity or water, allocation of financial resources, or allocation of vaccine supplies.

In some embodiments, the generated prospective resource allocations may be obtained by other operations or applications for downstream applications. For example, the generated prospective resource allocations may be for display on user interfaces (see e.g., FIG. 4A). In another example, the generated prospective resource allocations may be obtained by other applications for identifying cash flow metrics at specific future points in time based at least in part on the predicted/generated prospective resource allocations.

In some embodiments, based on the generated prospective data records representing prospective resource allocation(s), one or more control options may be generated and displayed by system 100 to a user to manage the resource consumption. For example, the control options may allow the user to pre-emptively change, limit or otherwise configure (or control) the resource consumption in view of the generated prospective resource allocation, with one or more user input including a value for a user-adjustable parameter. The system may generate and route the control commands based on the received user input to cause another system or server, either internal or external, to implement the user-specified changes, limits or configurations of the resource consumption.

In some embodiments, processor 104 may: cause to render, at the display device, one or more graphical user interface elements displaying a user-adjustable parameter for controlling a resource consumption associated with the resource account; receive at least one user input representative of a value for the user-adjustable parameter; generate a command signal based on the value for the user-adjustable parameter; and transmit the command signal to an external server for controlling the resource consumption associated with the resource account.

In some embodiments, processor 104 may: generate one or more recommended values for the user-adjustable parameter based on the historical resource allocations from the user account; and cause to render, at the display device, the one or more graphical user interface elements displaying the user-adjustable parameter for controlling the resource consumption associated with the resource account with the one or more recommended values.

In some embodiments, processor 104 may: compute, using the trained neural network architecture, an updated predicted resource allocation amount associated with the first identifier and the second identifier based on the derived input features and the value for the user-adjustable parameter for controlling the resource consumption associated with the resource account; and cause to display, at the display device, the updated predicted resource allocation amount.

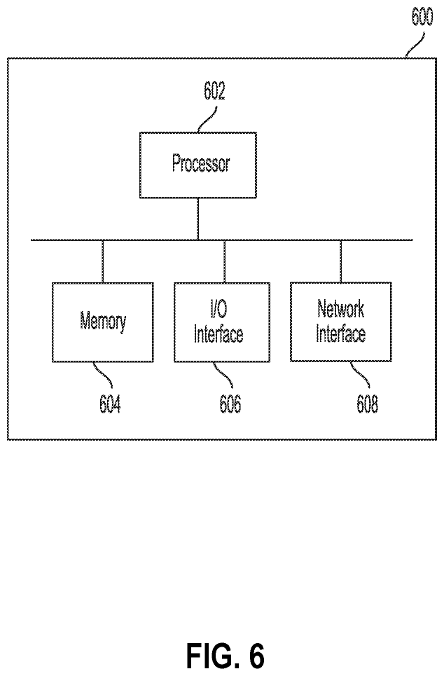

FIG. 6 is a schematic diagram of an example computing device 600 that implements a system (e.g., system 100), in accordance with an embodiment. As depicted, computing device 600 includes one or more processors 602, memory 604, one or more I/O interfaces 606, and one or more network interfaces 608.

For example, the instructions stored in memory device 108 of system 100 implemented using computing device 600, operate to transform the computing device 600, when executed by the instructions, into a special purpose machine that can generate one or more resource consumption predictions, and operable to generate one or more recommended values for the user-adjustable parameter based on the predictions and historical resource allocations from the user account; and cause to render, at the display device, the one or more graphical user interface elements displaying the user-adjustable parameter for controlling the resource consumption associated with the resource account with the one or more recommended values.

Each processor 602 may be, for example, any type of microprocessor or microcontroller, a digital signal processing (DSP) processor, an integrated circuit, a field programmable gate array (FPGA), a reconfigurable processor, a programmable read-only memory (PROM), or any combination thereof.

Memory 604 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 604 may store code executable at processor 602, which causes training system to function in manners disclosed herein. Memory 604 includes a data storage device or hardware. In some embodiments, the data storage device includes a secure datastore.

Each I/O interface 606 enables computing device 600 to interconnect with one or more input devices, such as a keyboard, mouse, camera, touch screen and a microphone, or with one or more output devices such as a display screen and a speaker.

Each network interface 608 enables computing device 600 to communicate with other components, to exchange data with other components, to access and connect to network resources, to serve applications, and perform other computing applications by connecting to a network such as network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The methods and processes disclosed herein, including the process 500 described above in view of FIG. 5, may be implemented using a system that includes multiple computing devices 600. The computing devices 600 may be the same or different types of devices.

For example, and without limitation, each computing device 600 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

The term “connected” or “coupled to” may include both direct coupling (in which two elements that are coupled to each other contact each other) and indirect coupling (in which at least one additional element is located between the two elements).

Each computing devices may be connected in various ways including directly coupled, indirectly coupled via a network, and distributed over a wide geographic area and connected via a network (which may be referred to as “cloud computing”).

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references are made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A system for machine learning architecture for prospective resource allocations comprising:
a processor; and
a memory device coupled to the processor and storing processor-executable instructions that, when executed, configure the processor to:
receive a sequence of data records representing historical resource allocations from a user account associated with a first identifier to a resource account associated with a second identifier;
derive input features based on the sequence of data records representing the historical resource allocations;
compute, using a trained neural network architecture, a predicted resource allocation amount and a predicted resource allocation date for the predicted resource allocation amount associated with the first identifier and the second identifier based on the derived input features;
determine, using the trained neural network architecture, a first selection score associated with the predicted resource allocation amount and a second selection score associated with the predicted resource allocation date; and
when the first or second selection score is above a minimum threshold, cause to display, at a display device, the associated resource allocation amount or date corresponding to the second identifier.

2. The system of claim 1, wherein the processor-executable instructions, when executed, configure the processor to:
cause to render, at the display device, one or more graphical user interface elements displaying a user-adjustable parameter for controlling a resource consumption associated with the resource account;
receive at least one user input representative of a value for the user-adjustable parameter;
generate a command signal based on the value for the user-adjustable parameter; and
transmit the command signal to an external server for controlling the resource consumption associated with the resource account.

3. The system of claim 2, wherein the processor-executable instructions, when executed, configure the processor to:
generate one or more recommended values for the user-adjustable parameter based on the historical resource allocations from the user account; and
cause to render, at the display device, the one or more graphical user interface elements displaying the user-adjustable parameter for controlling the resource consumption associated with the resource account with the one or more recommended values.

4. The system of claim 2, wherein the processor-executable instructions, when executed, configure the processor to:
compute, using the trained neural network architecture, an updated predicted resource allocation amount associated with the first identifier and the second identifier based on the derived input features and the value for the user-adjustable parameter for controlling the resource consumption associated with the resource account; and
cause to display, at the display device, the updated predicted resource allocation amount.

5. The system of claim 1, wherein the trained neural network architecture comprises a residual long short-term memory (LSTM) network including blocks of stacked LSTMs with residual connections between blocks.

6. The system of claim 5, wherein an input to the LSTM network comprises a feature vector comprising a concatenation of a plurality of input features.

7. The system of claim 1, wherein during training of the neural network architecture, the neural network architecture is configured to generate a plurality of outputs associated with one or more time steps, the plurality of outputs comprising: a predicted head amount, a predicted auxiliary amount, an amount selection score, a predicted head date-delta, a predicted auxiliary date-delta, and a date selection score.

8. The system of claim 7, wherein the training of the trained neural network architecture is based on the predicted auxiliary amount and the predicted auxiliary date-delta.

9. The system of claim 1, wherein the processor-executable instructions, when executed, configure the processor to:
generate one or more adjusted prospective resource allocations corresponding to the second identifier based on self-attention operations, wherein the adjusted prospective resource allocations comprise a dynamic weighted average of prior observed resource allocation values.

10. The system of claim 9, wherein a plurality of weights in the dynamic weighted average are determined based on a current output representation of the neural network architecture at a current time step and one or more previous output representations of the neural network architecture from one or more previous time steps.

11. A computer-implemented method for machine learning architecture for prospective resource allocation, the method comprising:
receiving a sequence of data records representing historical resource allocations from a user account associated with a first identifier to a resource account associated with a second identifier;
deriving input features based on the sequence of data records representing the historical resource allocations;
computing, using a trained neural network architecture, a predicted resource allocation amount and a predicted resource allocation date for the predicted resource allocation amount associated with the first identifier and the second identifier based on the derived input features;
determining, using the trained neural network architecture, a first selection score associated with the predicted resource allocation amount and a second selection score associated with the predicted resource allocation date; and
when the first or second selection score is above a minimum threshold, causing to display, at a display device, the associated resource allocation amount or date corresponding to the second identifier.

12. The method of claim 11, further comprising:
causing to render, at the display device, one or more graphical user interface elements displaying a user-adjustable parameter for controlling a resource consumption associated with the resource account;
receiving at least one user input representative of a value for the user-adjustable parameter;
generating a command signal based on the value for the user-adjustable parameter; and
transmitting the command signal to an external server for controlling the resource consumption associated with the resource account.

13. The method of claim 12, further comprising:
generating one or more recommended values for the user-adjustable parameter based on the historical resource allocations from the user account; and
causing to render, at the display device, the one or more graphical user interface elements displaying the user-adjustable parameter for controlling the resource consumption associated with the resource account with the one or more recommended values.

14. The method of claim 12, further comprising:
computing, using the trained neural network architecture, an updated predicted resource allocation amount associated with the first identifier and the second identifier based on the derived input features and the value for the user-adjustable parameter for controlling the resource consumption associated with the resource account; and
causing to display, at the display device, the updated predicted resource allocation amount.

15. The method of claim 11, wherein the trained neural network architecture comprises a residual long short-term memory (LSTM) network including blocks of stacked LSTMs with residual connections between blocks.

16. The method of claim 15, wherein an input to the LSTM network comprises a feature vector comprising a concatenation of a plurality of input features.

17. The method of claim 1, wherein during training of the neural network architecture, the neural network architecture is configured to generate a plurality of outputs associated with one or more time steps, the plurality of outputs comprising: a predicted head amount, a predicted auxiliary amount, an amount selection score, a predicted head date-delta, a predicted auxiliary date-delta, and a date selection score.

18. The method of claim 17, wherein the training of the neural network architecture is based on the predicted auxiliary amount and the predicted auxiliary date-delta.

19. The method of claim 1, further comprising:
generating one or more adjusted prospective resource allocations corresponding to the second identifier based on self-attention operations, wherein the adjusted prospective resource allocations comprise a dynamic weighted average of prior observed resource allocation values.

20. A non-transitory computer-readable medium having stored thereon machine interpretable instructions which, when executed by a processor, cause the processor to perform:
receiving a sequence of data records representing historical resource allocations from a user account associated with a first identifier to a resource account associated with a second identifier;
deriving input features based on the sequence of data records representing the historical resource allocations;
computing, using a trained neural network architecture, a predicted resource allocation amount and a predicted resource allocation date for the predicted resource allocation amount associated with the first identifier and the second identifier based on the derived input features;
determining, using the trained neural network architecture, a first selection score associated with the predicted resource allocation amount and a second selection score associated with the predicted resource allocation date; and
when the first or second selection score is above a minimum threshold, causing to display, at a display device, the associated resource allocation amount or date corresponding to the second identifier.
